(19) United States
(12) Patent Application Publication
(10) Pub. No.: US 2008/0306811 A1
(43) Pub. Date: Dec. 11, 2008

(54) Method system and device to evaluate employees and employers

(76) Inventors: Yael Goldman, Ramat Gan (IL); Efraim Goldman, Ramat Gan (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/811,319

(22) Filed: Jun. 11, 2007

(51) Int. Cl. G06F 11/34

(52) U.S. Cl. 705/11

(57) ABSTRACT

A video recorded professional interview and assessment of potential employees for the benefit of employers so the latter can examine potential employees at times and speed convenient to the employers selecting only those most suitable for live interviews.

A video recorded professional interview and assessment of employers for the benefit of employees so that the latter can examine potential employers to avoid wasting time with interviews that can be identified ahead of time as being likely to be incompatible.

Use of parameters to aid the analysis of the interviewee for example, blood pressure, heart beat, eye movement, body movement and the like. Use of internet for authorized viewers to see pool of potential candidates.

### FIELD OF THE INVENTION

This invention is in the field of employment interviews that are recorded professionally for the benefit of both the employer and employee.

### BACKGROUND of the INVENTION

Interviewing employees is a time consuming exercise that is done by employers in their attempt to find the best suited candidate. Sometimes they will rely on employment agents rather than advertise directly and these agents sometimes manage to filter out the potentially unsuitable applicants. There is often a lack of professionalism when conducting interviews and if the wrong person is employed it can cause serious and long term damage to the employer before he discovers the problem. Then the cycle repeats itself as the employer will start looking for a more suitable employee. The other side of the interviewing business is no less full of problems. Potential employees go to interviews with potential employers who are often unsuitable for them, either because the conditions of work are unsuitable or the qualifications of the employee are unsuitable or for other reasons. The potential employee often has to travel to distant places and to addresses unfamiliar to him only to find out very quickly that the journey was a waste of time and money. If the interviewee (the potential employee) is at the time employed with a different employer, this situation is doubly frustrating and could lead to him to endanger his current job because of the time needed to take from his job to go to interviews.

For all these reasons and more there is a need for a novel alternative to conventional interviewing methods and this innovation answers most of the above problems.

The closest example to the present invention of prior art in this field is seen in patent application number 2005261957 issued to Fisher et al. that reveals a method of assessing employees using professional interviewers and assessors to assess employees for the benefit of employers with interview training for employees. The Fisher application does not use technology like video nor analysis of behavior characteristics during the interview nor data base information for the employer and employee on CD nor using the internet for registered clients nor using a computer program to make the above assessment of the interviewee.

This invention reveals a number of unique methods for carrying out interviews, analyzing them using various professional parameters and enabling employers and employees to have access to the interviews and analyzed results relevant to their respective needs.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

This invention involves professional interviewers interviewing employees and employers and making a data base of each so that when an employer seeks a particular kind of employee or visa versa the seeking side could be given details of relevant candidates. Such detail could be transmitted by what means is convenient and agreed by the parties for example, on CD, printed (suitable for text reports, written assessments and written recommendations), email or on an internet web site where only authorized viewers could see the detail relevant to them.

An object of the invention is to provide interview material recorded visually and verbally with professional interviewers and professional assessment, comment and report of each interviewee that is relevant to a particular employer. The requirements of the employers will have been made known to the interviewing company and so only relevant interviewees would be referred to them.

Another object of the invention is to professionally analyze and report using additional methods of analysis for example, graphology, polygraph, heart-rate and blood-pressure, facial expression and body movement, eye contact voice intonation, speech and vocabulary analysis and the like. Other factors that could be analyzed and reported may vary according to the type of job and demands of the client, for example, concerning make-up, hair style, dress mode, and the like.

Another object of the invention is for a computer program to analyze part or all the above factors of analysis in relation to interviewees and produce a report of its findings.

Another object of the invention is for a professional, for example a psychologist, to assess the needs of the employer and interview the potential employees and prepare a report of each employee after analyzing all relevant factors including the visual video recording of himself interviewing the interviewee.

Another object of the invention is to interview employers optionally on video to explain the nature of the job being offered, the work ethic of the company, the minimum educational and professional qualifications and work experience required so that potential employees can decide which employers are more suitable to ask for interviews. Another object of the invention is to film potential interviewees when they are taking tests like for example psychometric tests. One of the purposes of this filming being to analyze not only the direct results of the test but also other factors for example the interviewee's ability to make the best decisions in circumstances of time-restraint and stress, the stamina factor and their behavior in such difficult situations. The analysis of these interviews could be done by professionals or by a computer program designed for this purpose, namely to objectively analyze all the above mentioned factors of interviewees.

Another object of the invention is to store the results of the analysis of interviews, reports and recommendations in a digital memory bank on and/or off an internet web site for the benefit of potential employers and employees.

Another object of the invention is to carry out interviews with video recording in the home of the interviewee with the aid of a computer program that would conduct the interview, set the tests and produce an analyzed report based on all or some of the factors above mentioned.

Another object of the invention is to implement the objects of the invention or any portion of them whilst adhering to relevant legal requirements including those concerning privacy.

Another object of the invention is to create an information pool between (potential) employers so when one (potential) employee applies for a job all his details are available for inspection by all the (potential) employers in that field. The available information could include for example, an expert's opinion and analysis of the interview with the (potential) employee, the (potential) employer's personal opinion of the interview, test results and other relevant information. The purpose of such a pool of information is to enable (potential) employers to view on their computer or other screen detail regarding many (potential) employees without spending time carrying out those interviews themselves and with the benefit of the expert opinion, test results and so on. The said expert opinion could be filmed and marketed as an item in its own right that would be a useful tool for (potential) employers.

Another object of the invention is to create a verification system whereby the facts reported by (potential) employees in their c.v.'s and when filling in application forms can be checked with the relevant bodies. For example, there could be an agreement with schools, universities, other institutions of learning and government offices who could verify that the (potential) employee did in fact receive the degree, or the grades that he claimed in his c.v.

Another object of the invention is to offer training to (potential) employees to prepare them for interviews. This could include the use of language, body language, hair and make-up.

Another object of the invention is to organize and film group dynamics. This could include group testing, group interviewing and group analysis of the testing and interviewing.

Another object of the invention is to provide the service of assisting the overlap and job handover procedure when personnel are changed. Often when a new employee starts his job his predecessor has already left and the latter's valuable knowledge of the job, work system and connections are lost. Other times the person about to leave the job is not totally co-operative with the new employee when revealing this information. This phenomenon is damaging to employers and can be avoided by this aspect of this innovation, namely, to film employees when they have had a significant amount of experience of the job and when there is not a threat to his position in that job.

The employee would be asked to explain his work procedures in detail and in different circumstances. He could be asked to produce lists of contacts connected to his work, whether clients, suppliers and other contacts related to the work. All this could be filmed and kept by the employer for use in the future. The employer could offer the employee a bonus or other benefit to encourage him to make a complete and detailed report.

### BRIEF DESCRIPTION of the DRAWINGS

The accompanying drawings, which are incorporated in and form a part of this specification, illustrate embodiments of the invention and, together with the description, serve to explain, by way of example only, the principles of the invention:

FIG. 1 is a flow chart showing various options of the operation of this invention where the employee is interviewed for the benefit of employers.

FIG. 2 is a flow chart showing various options of the operation of this invention where the employer is interviewed for the benefit of employees.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

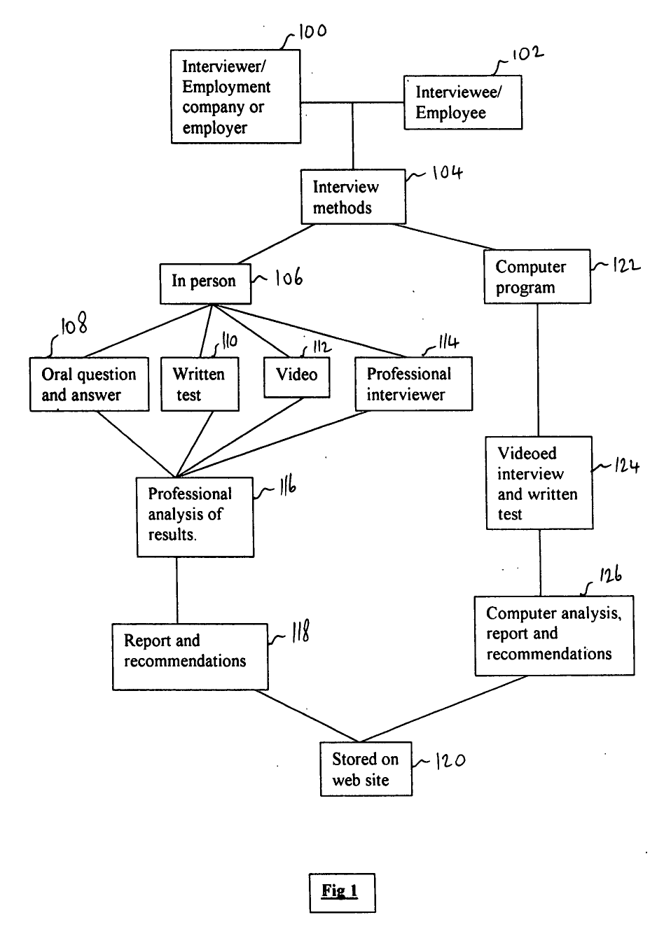

FIG. 1 shows various options of the operation of this invention where the employee is interviewed for the benefit of employers. This is the common situation where employers look for a suitable candidate to fill a vacancy in the workforce. The employer is the interviewer 100 or alternatively this role can be fulfilled by the employment company using this invention. The employer may wish to interview personally and still benefit from other aspects of this invention for example, the professional analysis and report. The employee 102 is the subject of the interview. The interview methods 104 are decided by the nature of the work and the particular needs of the client and could include one or more of the following parameters, graphology, polygraph, heart-rate and blood-pressure, facial expression and body movement, eye contact voice intonation, speech and vocabulary analysis.

The interview can be controlled and directed by a person 106 who could be a representative of the employer, a representative of the employment agency who could be a professionally trained interviewer.

The interview could be a list of questions and the answers could be recorded 108 or written questions requiring written replies 110. The preferable embodiment of this invention is for the interview to be verbal by a professional interviewer 114 and videoed 112. In this way the maximum effect will be obtained from the interview probably producing the richest results.

Whatever method is used to conduct the interview a professional from the employment company could examine and analyze the results of the interview 116. Those results could form the basis of a report and recommendations 118 of the employment company regarding that particular interviewee. The said interview and conclusions could be stored on a secured web site 120 where authorized persons would have access to inspect the interview, report and recommendations.

In another embodiment of this invention a computer program 122 carries out the interview, videos the interview 124 analyses the results and produces a report of its conclusions with recommendations 126. This information could likewise be stored on a secured web site 120.

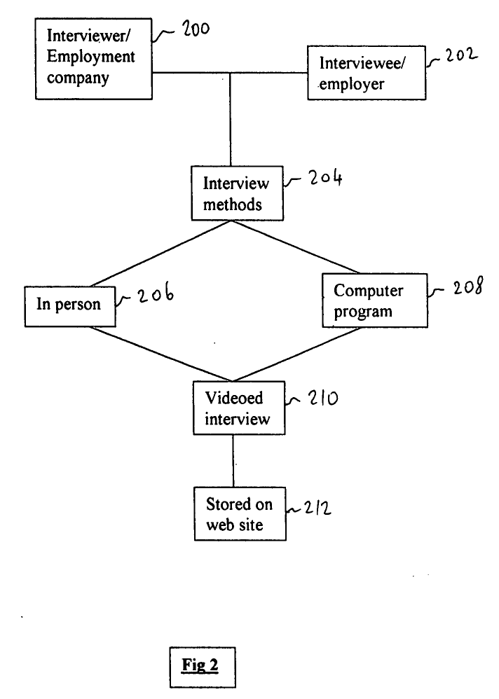

FIG. 2 shows various options of the operation of this invention where the employer is interviewed for the benefit of employees. Here the employment company 200 would control and conduct the interview and the interviewee would be the employer 202. As described in relation to FIG. 1 the appropriate interviewing methods 204 would be chosen according to the need. For example, in this kind of interview the body movements or heart rate of the employer would not be needed. The purpose of the interview is more to let the employer impart information about his company generally and the job vacancy in particular. This interview too could be carried out in person 206 or by a pre-prepared computer program 208. The interview would probably be videoed 210 and the resulting video could be stored on a secured web site 212.

What is claimed:

1. A method, system and device to evaluate potential employees comprising,
a. recording by electronic means an interview with the said employee,
b. testing the said employee with written and/or oral tests relevant to the particular needs of the job in question,
c. a means to measure in real time various factors concerning the physical and mental state of the employee during the interview being relevant to the analysis and report of the employee,
d. assessing, analyzing, and reporting the results of the said interview, said tests and said physical and mental state,
e. a means to record and securely save the said assessment, said analysis and said report, and
f. a software computer program to operate, control, store and retrieve those aspects of the said method, system and device that require computer technology,
whereby employers could examine the said interview, assessment, analysis and report for the purpose of choosing the most suited potential employee for the job.

2. A method, system and device as claimed in claim 1 further comprising the storage of the said interview, the said analysis and the said report on a web site.

3. A method, system and device as claimed in claim 2 wherein the said web site is secured so that only authorized persons could enter the said web site or a specific part of it.

4. A method, system and device as claimed in claim 1 wherein the said various factors concerning the physical and mental state of the employee during the interview include one or more of the following but not being limited to them, namely, graphology, polygraph, heart rate, blood pressure, facial expression, body movement, posture, eye contact, voice intonation, diction, vocabulary, dress mode, hair style and make-up.

5. A method, system and device as claimed in claim 1 wherein the said recording is on-line and could be examined in real-time.

6. A method, system and device as claimed in claim 1 wherein the said recording is stored digitally for examination at a later time.

7. A method, system and device as claimed in claim 6 wherein the said storage is on one or more of the following methods but not limited to them, namely CD, DVD, video, hard disk, disk on key and on the internet.

8. A method, system and device as claimed in claim 1 wherein the said interview is run by the employer who is seeking an employee.

9. A method, system and device as claimed in claim 1 wherein the said interview is run by a representative of an employment company.

10. A method, system and device as claimed in claim 1 wherein the said interview is run by a computer program created for the purpose of interviewing, testing, analyzing and reporting the conclusions.

11. A method, system and device as claimed in claim 1 wherein an information pool is created with the said recordings whereby potential employers can see the said recordings of relevant potential employees' interviews, test results, opinions of experts and fact verification thereby saving them from carrying out the same interview.

12. A method, system and device as claimed in claim 1 wherein an expert analysis and opinion of the said interview is visually or audibly recorded for the benefit of potential employers and potential employees.

13. A method, system and device as claimed in claim 1 wherein at least one of the said interview, the said testing, the said measurements, the said assessment, the said analysis and the said reporting of results is carried out with two or more interviewees at the same time in what is commonly known as group dynamics.

14. A method, system and device to evaluate employers comprising,
a. recording by electronic means an interview with the said employer,
b. a means to record digitally and securely save the said interview, and
c. a software computer program to operate, control, store and retrieve those aspects of the said method, system and device that require computer technology,
whereby employers could describe the nature of the job being offered, the work ethic of the company, the minimum educational and professional qualifications required for the job and prior work experience required, and
whereby potential employees could examine the said interview for the purpose of choosing the most suited potential employer for themselves.

15. A method, system and device as claimed in claim 14 further comprising the storage of the said interview, the said analysis and the said report on a web site.

16. A method, system and device as claimed in claim 15 wherein the said web site is secured so that only authorized persons could enter the said web site or a specific part of it.

17. A method, system and device as claimed in claim 14 wherein the said recording is on-line and could be examined in real-time.

18. A method, system and device as claimed in claim 14 wherein the said recording is stored digitally for examination at a later time.

19. A method, system and device as claimed in claim 18 wherein the said storage is on one or more of the following methods but not limited to them, namely CD, DVD, video, hard disk, disk on key and on the internet.

20. A method, system and device as claimed in claim 14 wherein the said interview is run by a representative of an employment company.

21. A method, system and device as claimed in claim 14 wherein the said interview is run by a computer program created for the purpose of interviewing employers.

22. A method, system and device as claimed in claim 1 wherein there is connection made by computer or otherwise with government authorities, schools, universities and other places of learning and training for the purpose of verifying the facts relating to the academic and professional qualifications claimed by a potential employee.

23. A method and system of training potential employees to improve their performance as interviewees including but not limited to the following namely, use of speech, intonation of the voice, body language, sitting posture, eye contact, clothing, hair style and make-up.

24. A method and device to ease the change of personnel by filming an incumbent employee carrying out his job including explaining relevant aspects and methods of the job, client and supplier lists and contacts used during the course of work over a specified period of time whereby personnel can be changed with reduced damage to the employer in a situation where the leaving employee is no longer present or refuses to reveal all his work methods and related information.
